(19) United States
(12) Patent Application Publication
(10) Pub. No.: US 2025/0131900 A1
(43) Pub. Date: Apr. 24, 2025

(54) Undroppable Guitar Pick Bracelet System

(71) Applicant: William Nelson Congleton, Seattle, WA (US)

(72) Inventor: William Nelson Congleton, Seattle, WA (US)

(21) Appl. No.: 18/491,219

(22) Filed: Oct. 20, 2023

(51) Int. Cl. G10D 3/173

(52) U.S. Cl. CPC G10D 3/173

(57) ABSTRACT

A bracelet, featuring a leash of adjustable length which extends from the adjustable wristband at a particular point generally at the top of the wrist, with a guitar pick attached to the other end of the leash. When the pick is in use, the leash extends between the thumb and index finger to where the pick is held, and behaves as a normal guitar pick. When the pick is dropped, it swings on the leash so that it is easy to control; the leash can hang completely out of the way down the back of the hand. There is also a storage feature such as a clip to store the pick and leash in a convenient, self-contained bracelet form. The system can be adjusted to accommodate the player's body and preference. It is a low-profile bracelet appropriate for everyday wear.

### BACKGROUND

### (1) Field of the Invention

The present application relates to a handheld plectrum (pick) which is used to play various stringed musical instruments such as guitars, and to ergonomic augmentations and enhancements of the original plectrum. The plectrum is generally a small, hard, flat object with at least one protruding tip for plucking the strings. These objects are notoriously easy to drop, difficult to pick up, and easy to lose. In these ways guitar picks are not perfectly convenient and ergonomic tools. Furthermore, different approaches to playing and different effects to be produced (such as finger style plucking or strumming in styles like flamenco) may require use of the hands incompatible with holding a pick. Situations where the pick must be dropped, or is dropped accidentally, and situations where a pick must be picked up or retrieved, completely disrupt playing. This leads most such instrument players to be limited, either to styles that do not use a pick, or to use it in general and truly need it in order to play normally.

### (2) Description of Related Art

There have been many developments to the basic simple plectrum to make the device more versatile, ergonomic, and convenient. Pick-dispensing receptacles (such as pick holders) and ergonomically shaped picks are the most common developments of the ability to grab a pick when necessary. Other ergonomic design improvements include making the pick more comfortable to hold, easier to grip, harder to drop, and easier to pick up off of a flat surface, and easier to see and locate, especially in low-light situations. There are also various inventions, less commonly used, which attach the plectrum to the player's fingers, hand, or wrist, or to a handle or extension to be held.

U.S. Patent No. 20230206886 describes a “Clippy Pic” comprising a pick, with a hole drilled through it, that is attachable by a clip to an accessory such as an earring. It is designed in such a way that the pick must be removed from the accessory in order to be used.

Similarly, U.S. Pat. No. 4,779,778 describes a “Music Article Jewelry System” comprising a pick and pick sleeve with slots that engage a “stabilizing fin” of a clip in order to be easily inserted or removed. It is designed in such a way that the pick must be removed from the accessory in order to be used.

U.S. Patent No. 20150255050 describes a device worn on the finger which allows the pick's position to be switched out of the way when not in use. The device is not intended to be normally worn out of the context of playing.

These three patents, No. 20150122106-A1, No. U.S. Pat. No. 9,466,271-B2, and No. U.S. Pat. No. 10,074,349-B2 describe the pick being attached to a harness worn around the thumb. There are various types of thumb picks and picks that attach to the fingers. These interfere with the normal method of playing and are not meant to be worn out of the context of playing.

U.S. Pat. No. 5,837,913 describes a finger loop attaching to a pick via a “resilient member” similar to a leash. This design takes up space in the palm and may interfere with normal playing. It is also not meant to be worn out of the context of playing.

U.S. Patent No. 20170352336 describes an “Aid for playing a stringed musical instrument”—a glove with guitar picks on the tips of the fingers—which is not meant to be worn out of the context of playing.

James Theodore Hollin, Jr. has developed variations of a system of grasping the pick using a type of strap or retainer, in U.S. Patent No. 20140076120 and No. 20100263515. In another development of this concept, U.S. Patent No. 20090229442, Claim 14 describes the possibility of an “elastomeric wristband device suitable for wearing on the wrist of a stringed musical instrument player”, but this device is still not intended to be worn outside of the context of playing. This does not describe the leash, orientation, or storage system that are disclosed here. These patents also describe specialized guitar picks to be used with the devices, they do not use standard or modified standard guitar picks.

U.S. Pat. No. 4,982,641 describes the wristband and leash and describes a length adjustment of the leash, but does not describe the ergonomic size adjustment system, the pick storage system, or the orientation of the leash to the hand which is disclosed here.

U.S. Pat. No. 5,413,020 describes another development in which the leash is an elastic element inside a hollow plastic tube that retracts if the pick is dropped. This describes something similar to the pick retrieval method oriented to the hand which is described here, but is certainly different in that the pick leash does not swing, but rather, retracts. Neither of these latter two designs are meant to be conveniently worn outside the context of playing.

### SUMMARY

A primary object of this invention is to prevent situations that interfere with the player's normal approach to playing guitar. It can accommodate any hand/wrist size or player preference, and any guitar pick of the player's choice can be adapted for use with it. The issue of dropping the pick is solved for by making the pick retrievable in a more developed way. When the pick is held and used normally, it is to be used as a completely normal guitar pick. When the pick is dropped it can still be controlled for. It is still possible for an interference with the guitar to occur, but it can easily be recovered from, and in a way that is less disruptive than dropping it entirely. To use finger styles, the pick is dropped down the back of the hand where it is much less likely to interfere. Because of the special orientation of the anchor point, the leash is more ergonomic and adjustable to the player's preference. The pick can also be stored on the wristband comfortably when not in use, while remaining immediately accessible for use. This is a bracelet which can be worn normally as an unobtrusive accessory.

The leash anchors to the wristband at a particular spot for best ergonomic function. This point is near the superior point of elevation when the guitar is being played, which is near the second metacarpal and the first webspace on the back of the hand. It is also a point on the wristband generally close to where the pick is held while playing. The length adjustment of the leash to the player's preference is based on that. The fact that this point stays generally at a higher elevation, near the dorsal part of the wrist, when worn makes it easy to swing the pick between the “dropped” and “held” positions. The section of wristband closest to the guitar while playing is as streamlined as possible to avoid interference with the guitar.

The undroppable guitar pick bracelet system is a lifestyle-friendly accessory for the guitarist or stringed instrument player who faces the associated logistical problems of using a plectrum. Prior designs have either solved for the usage application or for the convenience of storing a pick, but there has not been a satisfactory design that allows the pick to be worn normally beyond the context of playing, and used as it is worn.

### BRIEF DESCRIPTION OF THE DRAWINGS

FIG. 1 shows the entire anatomy of the undroppable guitar pick bracelet system. FIG. 1A is a schematic illustration represented by symbols and FIG. 1B is a view of an embodiment according to the concept.

FIG. 2 shows the system in its intended application of normal use as worn on the user's hand when playing. FIG. 2A shows the bracelet with the pick in the proper “dropped” position. FIG. 2B shows the pick hanging where the hand can grasp it and represents the player preference that the leash adjustment point adjusts to.

FIG. 3 illustrates the pick storage system. FIG. 3A is a schematic representation of the pick being stowed away. FIG. 3B is a schematic view of the pick being stowed away while being worn.

Indicators A, B, and C describe aspects of orientation of the system to the hand:
A is a point to which the “swinging point” of the leash is generally oriented, at or near the top or highest-elevation point of the wrist when playing.
B is the player's preferred leash length, semi-dependent on hand size and mostly dependent on personal style.
C is the adjustable location of the pick storage fixture on the wristband, dependent on A, B, and the player's preference.

### DETAILED DESCRIPTION

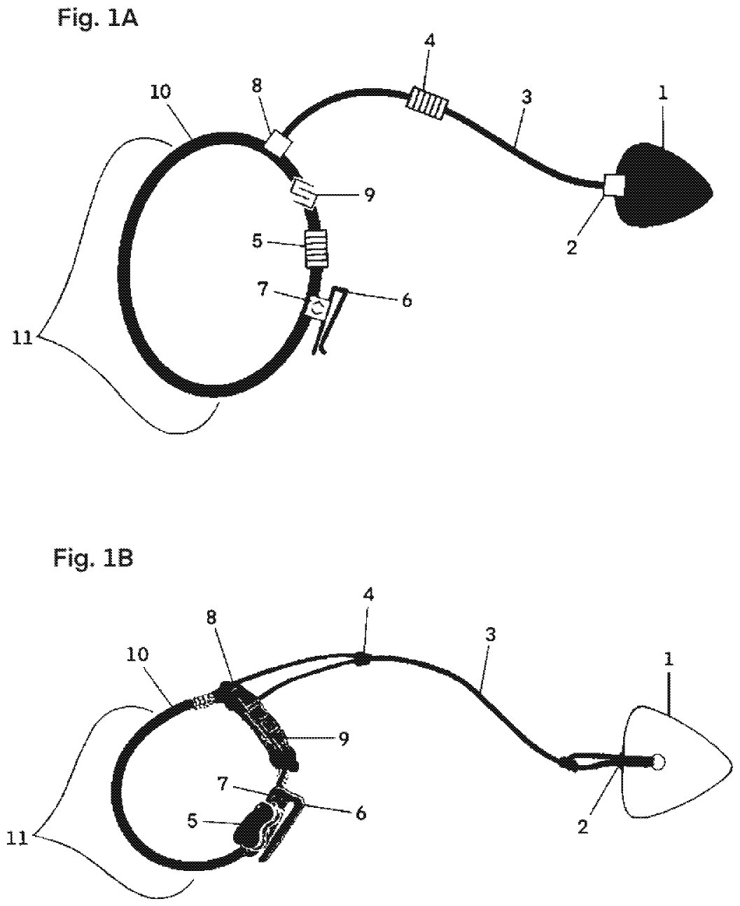

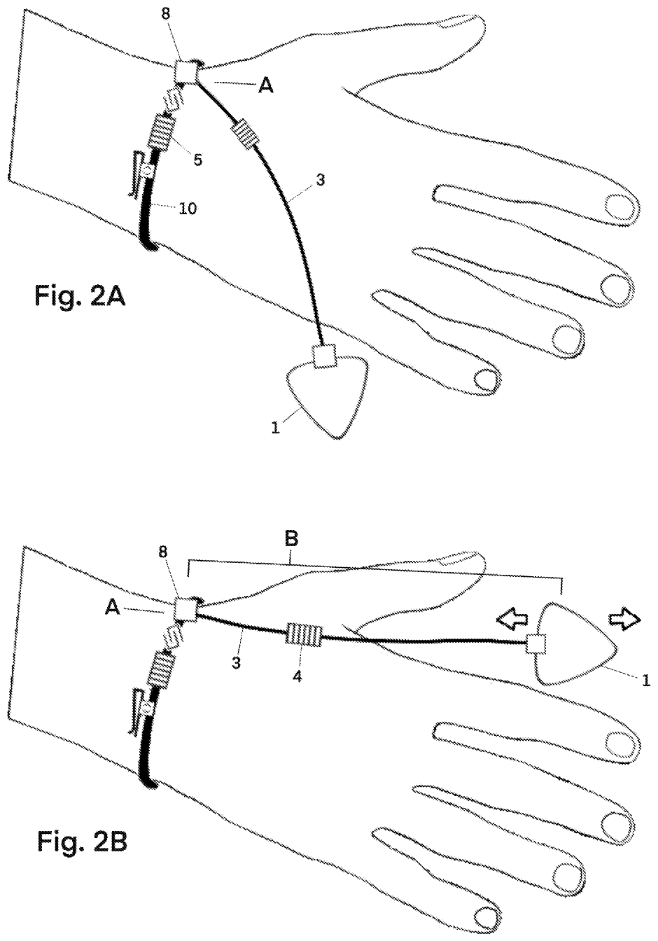

In order to wear the undroppable guitar pick bracelet system, the wristband 10 is either clasped, via a breakaway clasp 9, or slipped onto the wrist of the hand that holds the guitar pick 1. The wristband 10 is made to be lightweight, durable, and low-profile, and probably has some elastic properties to accommodate motion. FIG. 1B shows the wristband 10 represented as a band of 3 mm elastic shock cord, clasped at the ends by a plastic breakaway clasp. Wristband size adjustment 5 is set so that the wristband is comfortably snug to keep the wristband 10 in place without compromising range of hand motion, as in FIG. 2A. In FIG. 1B, the size adjustment is represented by a loop held with a clamping cord lock. The extreme end of the leash 3 opposite the end attached to the wristband 10 has a fastening point 2 for attaching to the pick 1. FIG. 1B shows fastening point 2 represented as a simple lark's head knot, tied through a hole in the pick, which may be fastened or unfastened. Other embodiments may not require a modification of the pick. The other end of the leash 3 attaches to the wristband 10 at anchor point 8, also known as the swinging point, which is oriented to point A (as in FIG. 2A and FIG. 2B), which is generally on top of the wrist when the hand is in a playing position, roughly in line with the index finger on the back of the hand. When the pick 1 is held between the index finger and the thumb, the leash 3 extends from point A across the first webspace of the back of the hand in between the index finger and the thumb, as in FIG. 2B. FIG. 2B illustrates how the leash length adjustment 4 is adjusted to be oriented to B, the user's preferred length. In FIG. 1B, the leash length adjustment 4 is represented as a sliding barrel knot tied in non-elastic 1.5 mm nylon cord. The actual length can vary widely due to differences in style of use, almost regardless of hand size, but generally is between four and eight inches.

In a normal usage application, the section 11 of the wristband, generally opposite the swinging point 8 and the clasp 9, is the side closest to the instrument, and to the heel of the palm which is often used to brace the hand and mute the strings. It is intended to be low-profile and unobtrusive so as to be non-problematic to the function of the instrument and the normal style of playing.

There is a particular way to drop the pick 1 on purpose so that normal finger-playing styles can be performed. The pick 1 should be dropped behind the fingers so that the leash 3 hangs down the back of the hand, entirely out of the way of the interaction between fingers and strings, as in FIG. 2A. If the pick 1 is dropped in any other way, it could interfere with playing, so swinging the leash 3 back when not in use to keep it in this normal dropped position is occasionally necessary to prevent interference. The leash 3 can easily be swung around the anchor point 8 at point A. This swinging motion is in fact the biggest difference from a normal playing style—it is a compromise which is less disruptive than dropping a normal pick, and allows the user to switch between a pick style and a finger style completely, immediately, and with unprecedented ease. In order to grab the pick 1 again, it can be swung back to in between the index finger and thumb to be grasped immediately as in FIG. 2B.

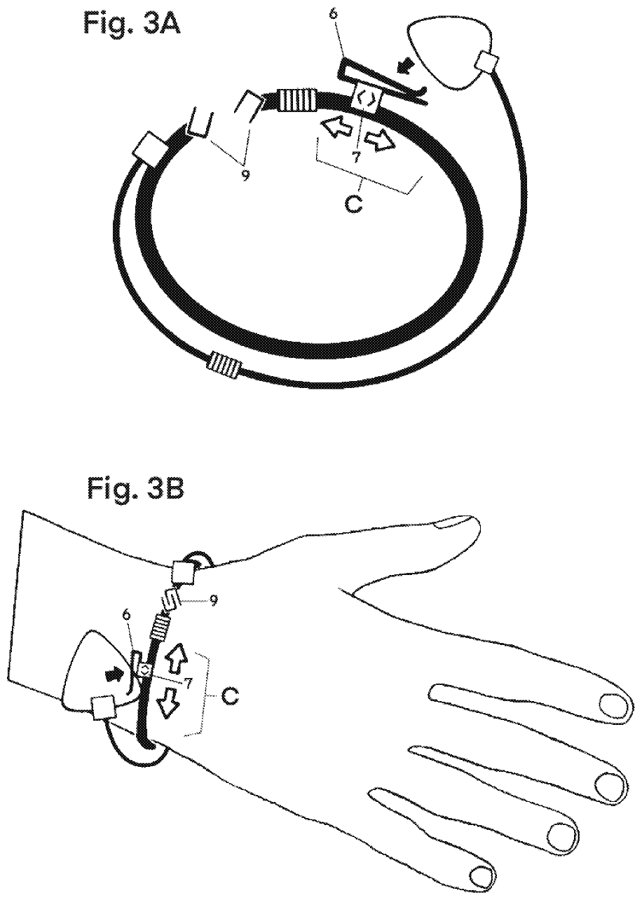

In order to store the pick 1 when it is not in use, the leash 3 wraps the long way underneath the wrist to the pick storage fixture 6 which is attached to an adjustable fastener 7 which is set to a location C on the wristband 10, as in FIGS. 3A & 3B. Location C is based on preference B and wristband size adjustment with relation to central swinging point A. The storage fixture 6 should be of a nature that prevents the pick 1 from easily falling out by accident, but allows it to be easily pulled out for use; in FIG. 1B, it is represented with a metal clip. When stored, the leash 3 does not pass across the clasp 9 so that the clasp can be opened and closed without interference as in FIG. 3A.

What is claimed is:

1. An ergonomic bracelet with a guitar pick on a tethering leash that is designed to be worn normally beyond the context of playing, comprising:
a. A wristband of adjustable size, that is designed to be comfortable while snug enough to keep it in a specific orientation while accommodating a range of motion and a range of hand sizes, and small enough to cause no interference while playing or while worn regularly;
b. The pick leash—a lightweight tether of adjustable length, with one end fastened to a guitar pick and the other end fastened to the wristband at a particular point;
c. A system and method of intended use—a way to wear the bracelet, a way for the pick to be dropped so it stays out of the way for playing the guitar without it, and a method of retrieving it.

2. A system of use as set forth in claim 1c, which is calibrated (oriented) to the player's hand, comprising:
a. The system of length adjustments which accommodates the player's size and preference;
b. The location of the point on the wrist which the anchor point of the leash to the bracelet generally lines up to;
c. The location of the section of the wristband that is meant to face the instrument;
d. A correct way to drop the pick so that it hangs out of the way down the back of the hand;
e. The way to maneuver the pick from the dropped position back to being held.

3. A bracelet system as set forth in claim 1, wherein a storage fixture on the wristband enables the pick and leash to be stowed in an unobtrusive way when not in use, so that it is wearable in an everyday context.
